(19) United States
(12) Patent Application Publication
(10) Pub. No.: US 2010/0302760 A1
(43) Pub. Date: Dec. 2, 2010

(54) Chemiluminescent Reagent Storing Device with Protection Casing and Chemiluminescent Device Using the Same

(76) Inventor: Zhaoyang Jin, Beijing (CN)

Correspondence Address: ALLEMAN HALL MCCOY RUSSELL & TUTTLE LLP, 806 SW BROADWAY, SUITE 600, PORTLAND, OR, 97205-3335, US

(21) Appl. No.: 12/745,487

(22) PCT Filed: Nov. 25, 2008
(86) PCT No.: PCT/CN08/01920

§ 371 Date: May 28, 2010

(30) Foreign Application Priority Data
Nov. 30, 2007 (CN) 200710178436.X

(51) Int. Cl. F21K 2/06; B65D 25/08

(52) U.S. Cl. 362/34; 206/219

(57) ABSTRACT

A chemiluminescent drug storing device with protection casing (1) comprising a crushable container (3) and a protective casing (1) provided on the external surface of the crushable container (3). The chemiluminescent drugs are sealed in the crushable container (3) and the protection casing (1) has at least one layer and has holes or gaps (2) to allow the flowing out of the chemiluminescent drugs. The chemiluminescent device comprises a transparent or translucent housing (4) and a chemiluminescent drug storing device with protection casing (1), the housing (4) is a deformable and sealed housing and has a cavity (5) inside, and the chemiluminescent drugs storing device is provided in the cavity (5).

### FIELD OF THE INVENTION

This invention is related to the field of the chemiluminescent device, and especially relates to a chemiluminescent reagent storage device with a protective wrap and the use thereof.

### DESCRIPTION OF THE RELATED ART

Traditional chemiluminescent devices can generate lighting effects when two chemiluminescent reagents mix; this reaction relies on the bending of the transparent shell and the breakage of inner glass. Because of the danger of the inner broken glass, the basic chemiluminescent device should use a shell of high thickness and high hardness in order to protect the inner glass and also to prevent puncture of it from the breaking of the inner glass. Moreover, such a structure of a chemiluminescent device is limited to only be in the shape of a stick or a similar form, where its usage is similarly limited.

### INVENTION PUBLICATION

The object of this invention is to supply a chemiluminescent reagent storage device with a protective wrap and the use thereof.

The chemiluminescent reagent storage device with a protective wrap provided in this invention includes a breakable container which is provided with at least one layer of protective wrap on its surface, and the protective wrap is provided with holes or gaps that facilitate the chemiluminescent reagents outflow from the breakable container.

In the chemiluminescent reagent storage device with a protective wrap described above, the diameter of the hole is between 0.001 mm and 2 mm, where the best diameter is between 0.5 mm and 1 mm; the width of the gap is formed of the natural distance between fibers. The material making said protective wrap is plastic, rubber, fiber fabric, metal, or non-woven fabrics, wherein, the plastic is selected from PE, PP, or Nylon; the fiber fabric is one of following materials or any combination thereof: cotton, polymer resin, metal, fiberglass, or carbon fiber. The protective wrap can be a sieve or a mesh grid, which can be orthogonal structure or oblique diamond structure; the mesh grid can be of fixed cross point, and can be also of slipped and unfixed cross point; the fibers weaved into the mesh grid can be single sheaves or multi-sheaves. The breakable container can be placed into the mesh grid and can be wrapped with one layer or more. Moreover, the mesh grid can be knitted in the shape of pipe, with the breakable container inserted into the empty space of the knitted pipe, and similarly, many knitting pipes can be wrapped around the breakable container. The material composing said sieve or mesh grid is one of following materials or any combination thereof: cotton, polymer resin, metal, fiberglass, or carbon fibers. The protective wrap includes at least one breakable container and the material making said breakable container is: glass, polystyrene, thin aluminum tube, aluminum foil, and so on.

A layer of aluminum foil film is provided between the breakable container surface and the protective wrap; the aluminum foil film is wrapped around the surface of the breakable container, so the glass chips can not exit through the hole even if its diameter is bigger than they are. In the chemiluminescent reagent storage device with the protective wrap described above, the chemiluminescent reagents can be liquid or solid, and are sealed inside the breakable container. If there is more than one breakable container, the activator reagents and oxlate reagents can be sealed separately inside different breakable containers; different colors can be made for the chemiluminescent reagent storage device.

The chemiluminescent device provided in this invention includes a chemiluminescent reagent storage device with a protective wrap as described above and a shell, wherein said shell is a transparent or translucent deformable and sealed shell, in which the shell has a cavity, and the chemiluminescent reagent storage device with the protective wrap is placed inside the cavity.

In the chemilumenscent device described above, the shell is a layered shell, and the layers form the cavity. The chemiluminescent reagent storage device is placed between the layers. Such a layered shell can be a glove, a hat, a plastic bag, a mask, a three-dimensional letter, or a life vest; the cavity of said shell includes the reagent that can induce chemiluminescent reaction with the reagent stored inside the chemiluminescent reagent storage device with the protective wrap. The shell can be of various shapes, and as a result, the chemiluminescent device can be made into a glow glove, a glow hat, a glow plastic bag, a glow mask, a glow three-dimensional letter, or a glow life vest.

### DESCRIPTION OF THE DRAWINGS

FIG. 1 is a structural representation of the chemiluminescent reagent storage device with a protective wrap.

FIG. 2 is a structural representation of the chemiluminescent reagent storage device with a protective wrap provided by example 1.

FIG. 3 is a structural representation of the chemiluminescent reagent storage device with a protective wrap provided by example 2.

FIG. 4 is a structural representation of the chemiluminescent reagent storage device with a protective wrap provided by example 3.

FIG. 5 is an A-A cross-sectional view of FIG. 4.

FIG. 6 is a structural representation of the chemiluminescent reagent storage device with a protective wrap provided by example 4.

FIG. 7 is a B-B cross-sectional view of FIG. 6.

FIG. 8 is a structural representation of the chemiluminescent reagent storage device with a protective wrap provided by example 5.

### BEST PRACTICES OF THE INVENTION

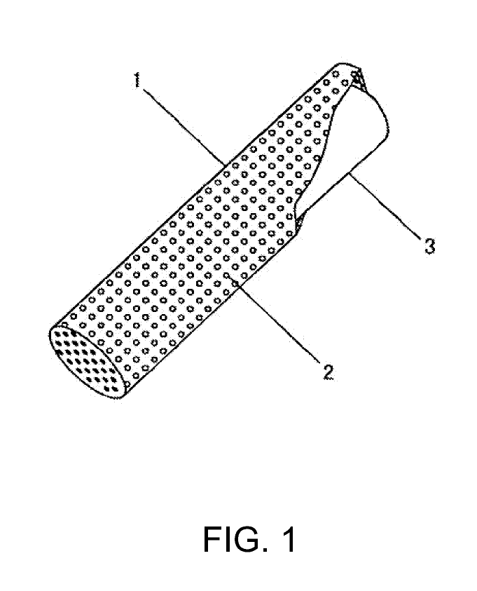

The structural representation of the chemiluminescent reagent storage device with a protective wrap provided in this invention is shown in FIG. 1, 1 is a protective wrap protective wrap 1 is provided with a hole 2 that facilitates the chemiluminescent reagent outflow; 3 is a breakable container sealed with chemiluminescent reagents and is placed inside the protective wrap.

### EXAMPLE 1

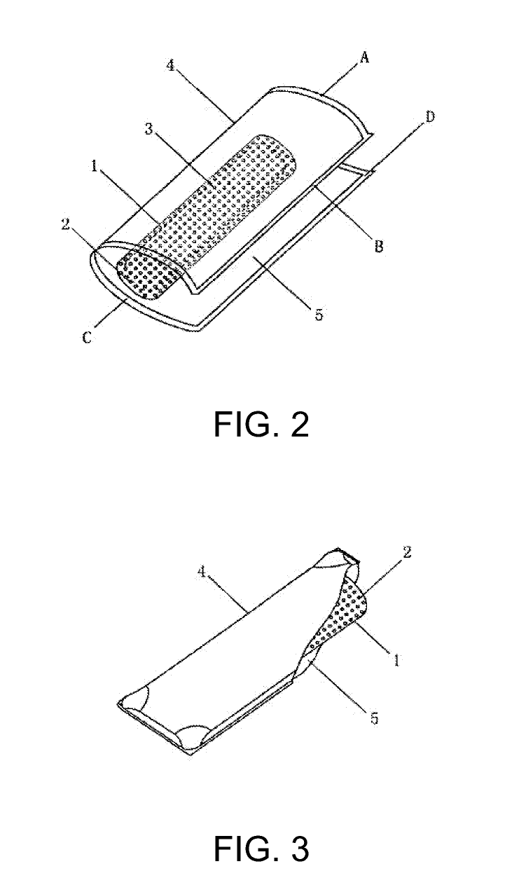

As illustrated in FIG. 2, the chemiluminescent reagent storage device with protective wrap into a transparent or translucent shell 4, 5 is a cavity. By folding the shell 4 in half, side A, side B, and side D are sealed into the shape of a tube to create the cavity 5. The chemiluminescent reagent storage device with the protective wrap and the chemiluminescent reagents is placed inside the cavity 5, and then side C is sealed into a chemiluminescent device.

In actual production, the three sides can randomly be sealed using two thin sheets of the shell 4, then inserting the chemiluminescent reagents and the chemiluminescent reagent storage device with the protective wrap, and then sealing the last side to create the chemiluminescent device.

If there is only one breakable container sealed with one kind of chemiluminescent reagent inside the protective wrap 1, then the other kind of chemiluminescent reagent is sealed inside the cavity 5; as a result, the chemiluminescent light is produced when the breakable container is broken. Generally, the activator reagent is sealed inside the cavity 5 and the oxalate reagent is sealed inside the breakable container 3 or vice versa.

### EXAMPLE 2

As illustrated in FIG. 3, this is an embodiment of the invention being applied to a transparent or translucent deformable and sealed shell 4, which constitutes the chemiluminescent device in the shape of a pillow. 5 is an inner cavity of the pillow that is, said cavity, and the chemiluminescent reagent device with a protective wrap is placed inside said cavity 5.

### EXAMPLE 3

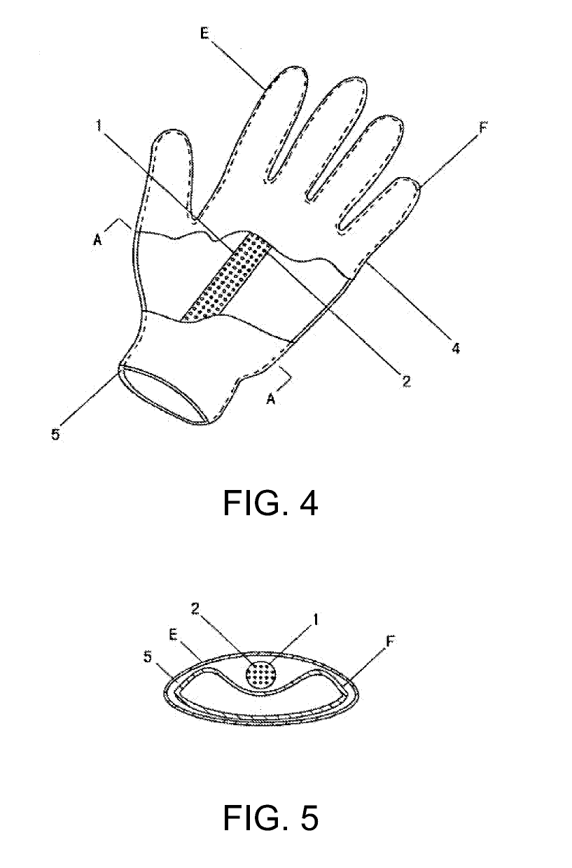

As shown in FIG. 4 and FIG. 5, a shell 4 is a whole glove, wrapped by two gloves together; glove F and glove E constitute the layered shell 4 by placing glove F and glove E together and the interior of said layers forms a cavity 5; the chemiluminescent reagent storage device with a protective wrap and the chemiluminescent reagents is placed into the cavity 5 and then gloves E and F are sealed to create a chemiluminescent glove.

### EXAMPLE 4

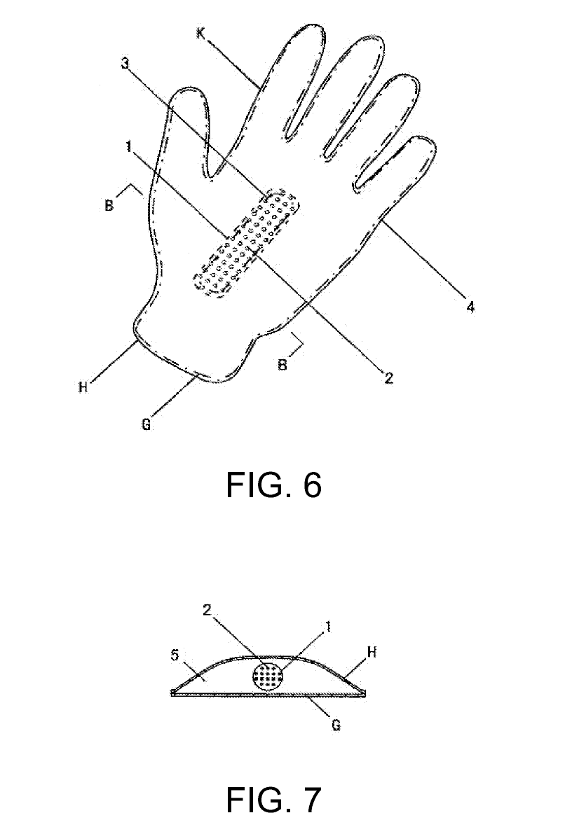

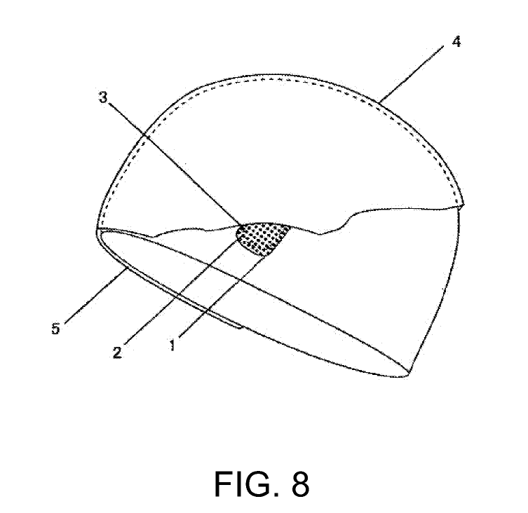

FIG. 6 and FIG. 7 illustrate sealing the single sheets G and H around the five fingers to form a cavity 5. The chemiluminescent reagent storage device with a protective wrap and chemiluminescent reagents is placed in the cavity 5, and sheets G and H are sealed together to create a chemiluminescent glove K, and then the two pieces of glove K or one piece of glove K and one piece of the thin sheet G are sealed around the five fingers to form a whole chemiluminescent glove. Wherein said two pieces of glove K or one piece of glove K and one piece of the thin sheet G constitute a layered shell 4, and an interior of said layers is the cavity 5.

### EXAMPLE 5

As shown in FIG. 8, a chemiluminescent reagent storage device with a protective wrap provided in this invention is applied into a hat, that is a shell is made 4 into a hat shape. Two hat shells comprising an inner and an outer make a layered shell, and two layers create the said cavity 5. A chemiluminescent reagent storage device with the protective wrap that can induce chemical light is placed into the cavity, and an edge of the two hat shells is sealed to create a chmiluminscent hat.

In actual production, a shell 4 can be made into any shape, such as a cartoon design, a letter, a waistband, a life vest and so on. In an actual production process, in order to make the chemiluminesent device have a uniform chemical light, an interior of a cavity can be provided with absorbent layers, which can be fiber fabrics or non-woven fabrics or paper.

During the production process, different sealing methods can be used if a volume of the chemiluminescent device is really big.

In the above examples, a shell is made of soft and thin material, such as PE, PP, or rubber, and at least one part of the shell is transparent or translucent.

### INDUSTRIAL APPLICATION

The instant chemiluminescent reagent storage device with a protective wrap alters the structure of the basic chemiluminescent device drastically. This protective wrap device improves the safety degree of the chemiluminescent device, decreasing the demand on the thickness and hardness of the shell and can be used for various shapes of chemiluminescent products and allows altering of the cosmetic appearance of the boring forms and tedious shapes of the current chemiluminescent products. These alterations are easy to activate, nice-looking, and greatly increase the interest and practicality of the chemiluminescent device.

1. A chemiluminescent reagent storage device, comprising:
a protective wrap;
a breakable container,
wherein said breakable container includes at least one layer of protective wrap on its surface; and said protective wrap includes holes or gaps that facilitate a chemiluminescent reagent outflow from the breakable container.

2. The chemiluminescent reagent storage device of claim 1, wherein a diameter of said holes is between 0.001 mm and 2 mm; and a width of said gap is formed of a natural distance between fibers.

3. The chemiluminescent reagent storage device of claim 2, wherein the diameter of said hole is between 0.5 mm and 1 mm.

4. The chemiluminescent reagent storage device of claim 1, wherein a material making said protective wrap comprises plastic, rubber, fiber fabric, metal, or non-woven fabric.

5. The chemiluminescent reagent storage device of claim 4, wherein said plastic comprises one or more of PE, PP and Nylon; and wherein said fiber fabrics comprises one or more of cotton, polymer resin, metal, fiberglass and carbon fiber.

6. The chemiluminescent reagent storage devices of claim 1, wherein said protective wrap is a sieve or a mesh grid, and a material making said sieve or said mesh grid comprises one or more of cotton, polymer resin, metal, fiber glass, or carbon fiber.

7. The chemiluminescent reagent storage devices of claim 1, wherein more than one breakable container is placed inside said protective wrap.

8. The chemiluminescent reagent storage device of claim 1, wherein a material making said breakable container comprises one or more of glass, polystyrene, thin aluminum tube, and aluminum foil.

9. The chemiluminescent reagent storage device of claim 1, wherein a layer of aluminum foil film is provided between said breakable container surface and said protective wrap, and said aluminum foil film is wrapped around a surface of said breakable container.

10. The chemiluminescent reagent storage devices of claim 1, wherein said breakable container is sealed with chemiluminescent reagents inside.

11. A chemiluminescent device, comprising:
a chemiluminescent reagent storage device, the chemiluminescent reagent storage devices including
a protective wrap;
a breakable container wherein said breakable container includes at least one layer of protective wrap on its surface; and said protective wrap includes holes or gaps that facilitate a chemiluminescent reagent outflow from the breakable container;
and a shell;
wherein said shell is a transparent or translucent deformable and sealed shell, wherein said shell has a cavity and said chemiluminescent reagent storage device is placed inside the cavity.

12. The chemiluminescent device of claim 11, wherein said shell is a layered shell comprising a plurality of layers and said chemiluminescent reagent storage device is placed between layers.

13. The chemiluminescent device of claim 12, wherein said layered shell is a glove, a hat, a plastic bag, a mask, a three-dimensional letter, or a life vest.

14. The chemiluminescent device of claim 12, wherein said cavity includes a reagent that can induce a chemiluminescent reaction with a reagent stored inside the chemiluminescent reagent storage device.

15. The chemiluminescent device of claim 14, wherein said chemiluminescent device is a glow glove, a glow hat, a glow plastic bag, a glow mask, a glow three-dimensional letter, or a glow life vest.

16. A chemiluminescent device, comprising
a chemiluminescent reagent storage device, the chemiluminescent reagent storage device including;
a protective wrap;
a breakable container wherein said breakable container includes at least one layer of protective wrap on its surface; and said protective wrap includes holes or gaps that facilitate a chemiluminescent reagent outflow from the breakable container, wherein a diameter of said holes is between 0.001 mm and 2 mm; and a width of the said gap is formed of a natural distance between fibers; and
a shell;
wherein said shell is a transparent or translucent deformable and sealed shell, wherein said shell has a cavity and said chemiluminescent reagent storage device is placed inside the cavity.

17. The chemiluminescent device of claim 16, wherein said protective wrap is a sieve or a mesh grid, and a material making said sieve or said mesh grid comprises one or more of cotton, polymer resin, metal, fiber glass, and carbon fiber.

18. The chemiluminescent device of claim 16, wherein a layer of aluminum foil film is provided between said breakable container surface and said protective wrap, and said aluminum foil film is wrapped around a surface of said breakable container.

19. The chemiluminescent devices of claim 16, wherein said breakable container is sealed with chemiluminescent reagents.

20. The chemiluminescent device of claim 16, wherein said cavity includes a reagent that induces a chemiluminescent reaction with a reagent stored inside the chemiluminescent reagent storage device.
